(19) United States
(12) Patent Application Publication
(10) Pub. No.: US 2026/0127453 A1
(43) Pub. Date: May 7, 2026

(54) SYSTEMS AND METHODS FOR ACQUIRING KNOWLEDGE BASED IN AI-GUIDED INTERVIEWS

(71) Applicant: Toyota Motor North America, Inc., Plano, TX (US)

(72) Inventors: Melody Ayeli, Richardson, TX (US); Paul Greenberg, Roslyn, NY (US); Stephen Ellis, Dallas, TX (US); Brian Kursar, Rolling Hills Estates, CA (US)

(73) Assignees: Toyota Motor North America, Inc., Plano, TX (US); Toyota Jidosha Kabushiki Kaisha, Toyota-shi Aichi-ken (JP)

(21) Appl. No.: 19/197,248

(22) Filed: May 2, 2025

Related U.S. Application Data
(60) Provisional application No. 63/715,223, filed on Nov. 1, 2024.

(51) Int. Cl. G06N 5/022; G10L 15/26

(52) U.S. Cl. CPC G06N 5/022; G10L 15/26

(57) ABSTRACT

A method for acquiring knowledge based on an interview is provided. The method includes obtaining, through an interface displayed on a screen, an objective of an interview from a user; deriving one or more topics from the objective of the interview using a large language model (LLM) and displaying, on the interface, the one or more topics; generating a plurality of questions using the LLM based on the objective of the interview and the derived one or more topics; providing the plurality of questions to a target user; obtaining answers to the plurality of questions from the target user; gathering the plurality of questions and the answers as knowledge units; and providing an answer to a question input by another user based on the knowledge units.

### CROSS-REFERENCE TO RELATED APPLICATION

This application claims the benefit of U.S. Provisional Application No. 63/715,223 filed on Nov. 1, 2024, the entire contents of which are herein incorporated by reference.

### TECHNICAL FIELD

The present specification generally relates to acquiring knowledge based in AI-guided interviews and, more specifically, to systems and methods for acquiring knowledge through streamlined interviews that conduct employee interviews based on AI generated questions and gather valuable insights and information from long-standing employees.

### BACKGROUND

Current large language models focus on knowledge retrieval. Specifically, a user requests information about a certain topic or question from a large language model (LLM), and the LLM provides the requested information to the user. However, LLMs mainly focus on knowledge retrieval from already known data, and does not implement knowledge acquisition.

### SUMMARY

The present disclosure provides an effective method of knowledge acquisition using a streamlined interview process between an interviewer and a target subject, i.e., an interviewee.

In one embodiment, a method for acquiring knowledge based on an interview is provided. The method includes obtaining, through an interface displayed on a screen, an objective of an interview from a user; deriving one or more topics from the objective of the interview using a large language model (LLM) and displaying, on the interface, the one or more topics; generating a plurality of questions using the LLM based on the objective of the interview and the derived one or more topics; providing the plurality of questions to a target user; obtaining answers to the plurality of questions from the target user; gathering the plurality of questions and the answers as knowledge units; and providing an answer to a question input by another user based on the knowledge units.

In another embodiment, a system for acquiring knowledge based on an interview is provided. The system includes one or more processors; and one or more memories for storing and encoding computer executable instructions that, when executed by the one or more processors is operative to: obtain, through an interface displayed on a screen, an objective of an interview from a user; derive one or more topics from the objective of the interview using a large language model (LLM) and displaying, on the interface, the one or more topics; generate a plurality of questions using the LLM based on the objective of the interview and the derived one or more topics; provide the plurality of questions to a target user; obtain answers to the plurality of questions from the target user; gather the plurality of questions and the answers as knowledge units; and provide an answer to a question input by another user based on the knowledge unit.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts an overview of an interview process, according to one or more embodiments shown and described herein;

FIG. 1B depicts schematic diagram of the present system, according to one or more embodiments shown and described herein;

FIG. 2 depicts a user interface for conducting an interview for knowledge acquisition, according to one or more embodiments shown and described herein;

FIG. 3 depicts a schematic diagram illustrating a flow chart of the process utilized by the interview system, according to one or more embodiments shown and described herein;

FIG. 4A depicts a schematic diagram of step 310. Wherein the knowledge acquisition system obtains, through an interface displayed on a screen, an objective of an interview from a user, according to one or more embodiments shown and described herein;

FIG. 4B schematically depicts the process of step 330. Wherein the knowledge acquisition system generates a plurality of questions using the LLM based on the objective of the interview and the derived one or more topics, according to one or more embodiments shown and described herein;

FIG. 5 depicts a user interface for when the knowledge acquisition system provides a plurality of questions to a target user and for when the target user answers a question, according to one or more embodiments shown and described herein;

FIG. 6 depicts a user interface for saved interview templates, according to one or more embodiments shown and described herein;

FIG. 7 depicts a knowledge graph compiled from multiple knowledge units, according to one or more embodiments shown and described herein;

FIG. 8 depicts a user interface for a conversation between a user and a virtual persona, according to one or more embodiments shown and described herein;

FIG. 9 depicts a user interface for reordering questions and answers according to one or more embodiments described herein; and

FIG. 10 depicts a user interface for where an interviewee may click the Record and Transcribe button, according to one or more embodiments shown and described herein.

### DETAILED DESCRIPTION

In embodiments, a user, as a knowledge acquisition specialist, seeks to leverage real-time insights from an AI agent to delve into pertinent subject matter areas and pose strategic questions so that the user ensures adherence to the interview plans, allows for the execution of pre-planned questions, and facilitates the incorporation of additional inquiries suggested by the AI agent based on the interviewee's responses, thereby enriching the knowledge transfer process.

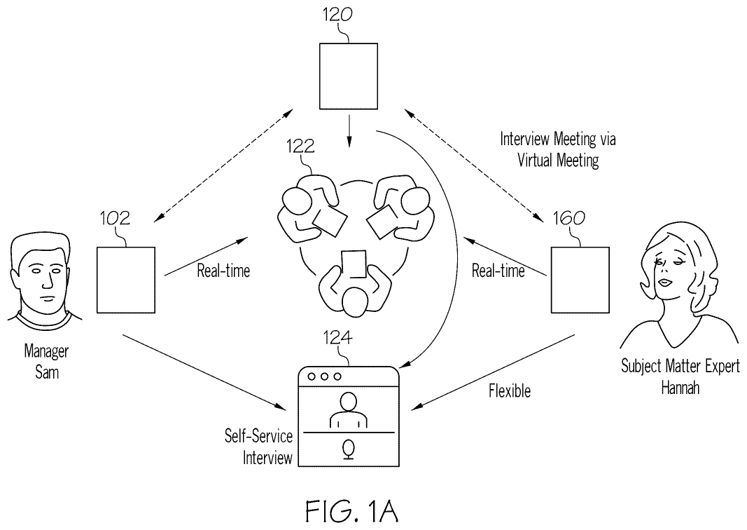

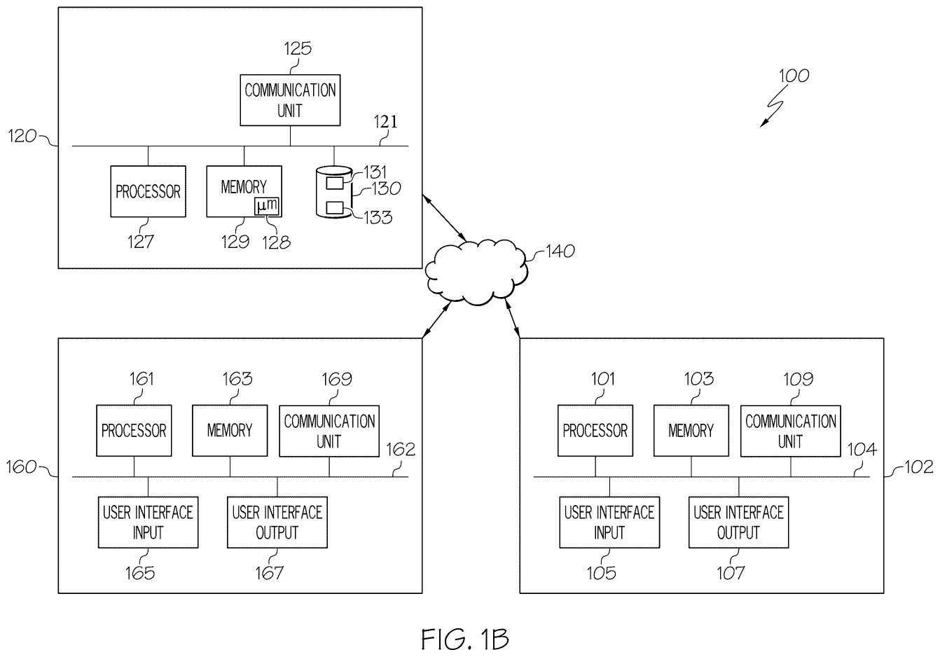

By referring to FIG. 1A, the present system provides two knowledge acquisition processes: knowledge acquisition through real-time meetings and knowledge acquisition through self-service interviews. The present system includes a first user device 102, as second user device 160, and a server 120. The first user device 102 may be the device of an interviewer and the second user device 160 may be the device of an interviewee who provides knowledge in a certain subject matter area. Each of the first user device 102 and the second user device may be a personal device including, but not limited to, a laptop computer, a desktop computer, a tablet computer, a smart phone, a wearable device, and the like.

Regarding the real-time interview, the interviewer, e.g., the manager Sam as a knowledge acquisition specialist, creates an interview plan with open ended questions using the first user device 102. In embodiments, the first user device 102 communicates with the server 120, and the server 120 provides a virtual meeting 122 where the user of the first user device 102 and the user of the second user device 160 can join. The server 120 may provide information that helps the interviewer interview the interviewee. For example, the server 120 receives an objective for the meeting from the first user device 102, generates one or more topics to discuss and questions related to the one or more topics, and provides the generated topics and the questions to the first user device 102. As another example, the server 120 may analyze the conversation between the interviewer and the interviewee in the virtual meeting and provide additional questions to the first user device 102 such that the interviewer may utilize the provided additional questions.

In embodiments, the server 120 may transmit the generated questions to the second user device 160, and the questions are displayed on the user interface of the second user device 160. The interviewee, e.g., the subject matter expect Hannah, answers the questions using the user interface of the second user device 160. Then, the AI model of the system may generate more questions that are more specific based on the answers and provide the questions to the interviewee. The AI model may be a large language model that receives objectives and/or topics as inputs and outputs a plurality of questions related to the objectives and topics.

In some embodiments, the AI model may be trained based on a knowledge graph. The knowledge graph organizes data from multiple sources, captures information about entities of interest in a given domain or task, and generates connections between entities. The knowledge graph may be generated based on already existing data such as knowledge units from interviewees or subject matters experts. The knowledge units may be sets of questions and answers to the questions. The knowledge units may include information other than questions and answers, e.g., identity information about an interviewee and/or interviewer, the time of the interview, the location of the interview, and the like.

FIG. 1B depicts schematic diagram of the present system, according to one or more embodiments shown and described herein.

The system 100 may include the first user device 102, the second user device 160, and the server 120. The server 120 may include a communication unit 125, a processor 127, a memory modules 129, and a database 130, which are communicatively coupled to a communication path 121. The communication path 121 may communicatively couple the communication unit 125, the processor 127, the memory modules 129, and the database 130. The server 120 is communicatively coupled to a network 140 (e.g., a cloud network, wireless network, etc.).

The communication unit 125 communicatively couple the server 120 to the network 140. The communication unit 125 may be any device capable of transmitting and/or receiving data with user devices (e.g., the first user device 102, the second user device 160) directly or via a network, such as the network 140. Accordingly, the communication unit 125 includes a communication transceiver for sending and/or receiving any wired or wireless communication. For example, the communication unit 125 may include an antenna, a modem, LAN port, Wi-Fi card, WiMax card, mobile communications hardware, near-field communication hardware, satellite communication hardware and/or any wired or wireless hardware for communicating with other networks and/or devices. In embodiments, the communication unit 125 may include hardware configured to operate in accordance with the Bluetooth wireless communication protocol and may include a Bluetooth send/receive module for sending and receiving Bluetooth communications.

The server 120 includes, for example, one or more processors 127 and one or more memory modules 129 storing one or more machine-readable instructions. The one or more processors 127 may include any device capable of executing machine-readable instructions. Accordingly, the one or more processors 127 may be a controller, an integrated circuit, a microchip, a computer, or any other computing device. The one or more processors 127 and the one or more memory modules 129 may be communicatively coupled to the other components of the system 100 via the network 140.

The one or more memory modules 129 may comprise RAM, ROM, flash memories, hard drives, or any device capable of storing machine readable and executable instructions such that the machine readable and executable instructions can be accessed by the one or more processors 127. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 129. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processors 127 along with the one or more memory modules 129 may operate as a controller for supporting an interview process.

The one or more memory modules 129 may store an LLM that generates one or more topics in response to receiving an objective of a meeting and generates a plurality of questions in response to receiving the objective and one or more topics.

In embodiment, the server 120 includes one or more databases 130 to store data associated with users. The one or more databases 130 may store a set of knowledge units 131 and a knowledge graph 133 that is generated and updated based on the set of knowledge units 131. Each of the knowledge units consist of a question provided to an interviewee and an answer to corresponding question provided by the interviewee. In some embodiments, the knowledge units 131 and/or the knowledge graph 133 may be utilized to train the LLM 128.

The first user device 102 may include one or more processors 101, one or more memory modules 103, a user interface input device 105, a user interface output device 107, and a communication unit 109. The one or more processors 101, the one or more memory modules 103, and the communication unit 109 may be similar to the one or more processors 127, the one or more memory modules 129, and the communication unit 125 of the server 120. The one or more memory modules 103 may store the same LLM as the LLM 128 in the server 120, or store a reduced version of the LLM 128 due to the limited storage space of the first user device 102.

The user interface input device 105 receives input from a user such as an interviewer or an interview organizer who tries to generate questions during an interview. The user input device may be a keyboard, a mouse, a touch pad, a mic, a camera, or any device that may receive information input from the user.

The user interface output device 107 may be a display or a speaker that may provide information to the user. For example, the user interface output device 107 may include any known or yet-to-be-developed display, such as LCD, LED, plasma, OLED, CRT, projection, holographic, electronic paper, or any other type of suitable output display. In embodiments, the user interface output device 107 may be interactive such that an interactive display being capable of providing functionalities of the user interface output device 107 and the user interface input device 105. If provided as a tactile display, the user interface output device 107 may be any device capable of providing tactile output in the form of refreshable tactile messages.

In embodiments, the user interface output device 107 may output a request for inputting an objective of an interview. The user of the first user device 102 may input an objective of an interview using the user interface input device 105. Then, the input objective is transmitted to the server 120, which in turn generates one or more topics related to the input objective. The user of the first user device 102 may request for generating questions related to the generated topics using the user interface input device 105. Then, the request is transmitted to the server 120, which in turn generates a plurality of questions using the LLM 128 based on the input objective and the one or more topics.

The second user device 160 may include one or more processors 161, one or more memory modules 163, a user interface input device 165, a user interface output device 167, and a communication unit 169. The one or more processors 161, the one or more memory modules 163, the user interface input device 165, the user interface output device 167, and the communication unit 169 may be similar to the one or more processors 101, the one or more memory modules 103, the user interface input device 105, the user interface output device 107, and the communication unit 109 of the first user device 102. The one or more memory modules 103 may store the same LLM as the LLM 128 in the server 120, or store a reduced version of the LLM 128 due to the limited storage space of the first user device 102.

A user, for example, an interviewee, may provide information associated with the user using the second user device 160 via the network 140. The information may include answers to questions generated by the server 120, feedback about the questions including reordering of the questions, removing some of the questions, editing the questions, and the like. The data provided by the user may be shared among the components communicatively coupled to the network 140.

### Real-Time Interview

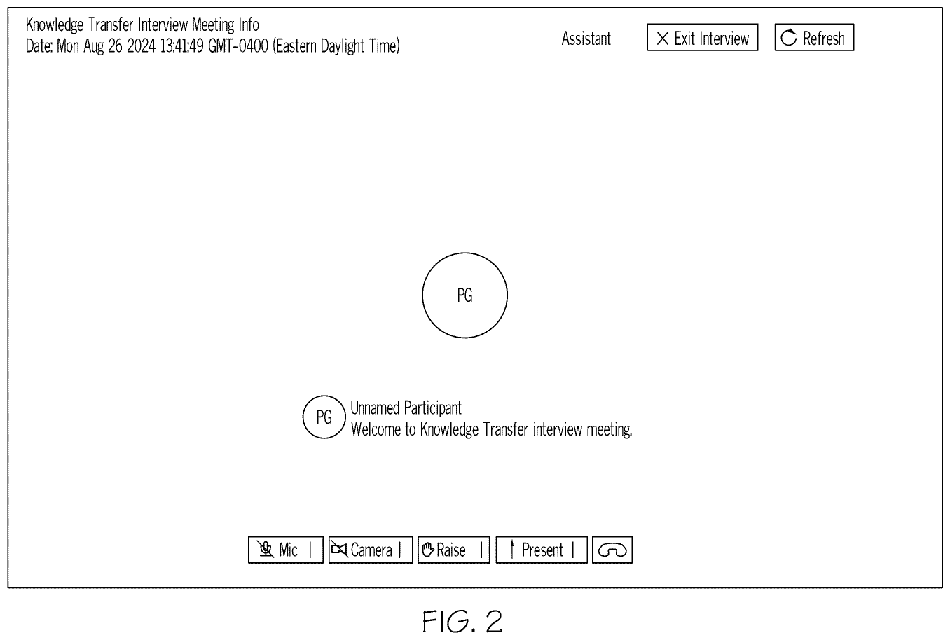

In embodiments, the server 120 may generate a virtual meeting 122 by communicating with the first user device 102 and the second user device 160. An interviewer may join the virtual meeting 122 using the first user device 102. FIG. 2 illustrates an example virtual meeting interface. An interviewee may join the virtual meeting 122 using the second user device 160. The server 120 may transcribe voices during the virtual meeting in real time, and generate new questions based on the transcription. The interface of the virtual meeting 122 may show a button for an assistant during the entire interview. Once the interviewer clicks the assistant button, new questions may be generated based on the conversations that were not included in the original interview plan.

In embodiments, during an interview, the interviewer may ask questions in real-time to the interviewee. The questions may be already generated by the AI model based on known information such as topic of the meeting, the information about the interviewee such as the expertise of the interviewee, the working department of the interview, the current or previous projects that the interviewee is working on, the resume of the interviewee, and the like. When the interviewee answers the questions, the present system converts the voice of the interviewee to text in real-time, and inputs the converted text to the AI model to generate additional questions for the interviewer to ask. The generated additional questions may be displayed on the interviewer's screen, and the interviewer asks follow-up questions

### Self-Service Interview

Regarding the self-service interview 124, the questions are generated by the interviewer and provided to the interviewee. The interviewee answers the questions and based on the answers, follow-up questions are generated by the AI model. In contrast with the real-time interview, the interviewee may dive deeper to specific areas by selecting and answering to certain questions.

Regarding the self-service interview 124, a knowledge capture system is provided. The interface of the knowledge capture system allows the user to choose type/field of the interview, such as legal and information technology. The user may be an interviewer. Then, the interface requests the user to write down the objective of the interview. Based on the received objective, the knowledge capture system generates a list of topics that are related to the objective. For example, the LLM 128 of the server 120 generates a list of topics in response to receiving the objective. The list of topics may be further generated if more details are added to the objective. In some embodiments, the user may select preferred topics out of the list of topics. Based on the generated topics or selected preferred topics, the knowledge capture system generates a list of questions. For example, the LLM 128 of the server 120 generates a plurality of questions based on the objective provided by the user and the list of topics generated by the LLM 128. The list of questions may be dynamically updated upon the request of the user.

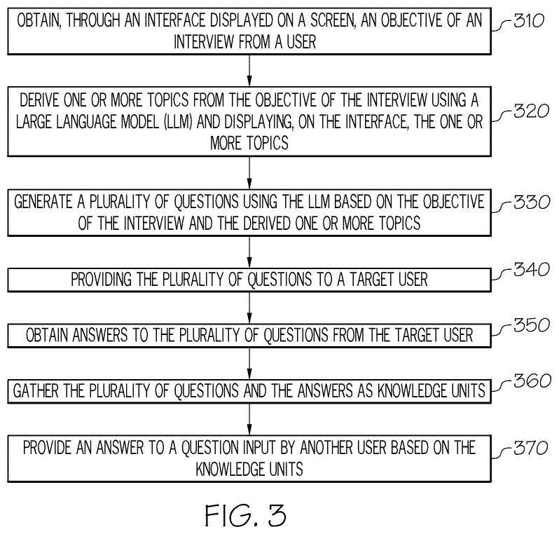

FIG. 3 depicts a flowchart for knowledge acquisition through an interview, according to one or more embodiments shown and described herein.

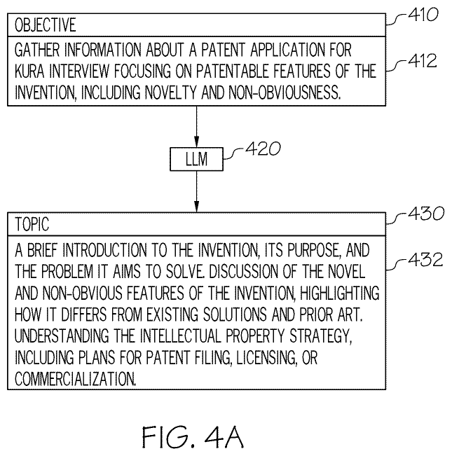

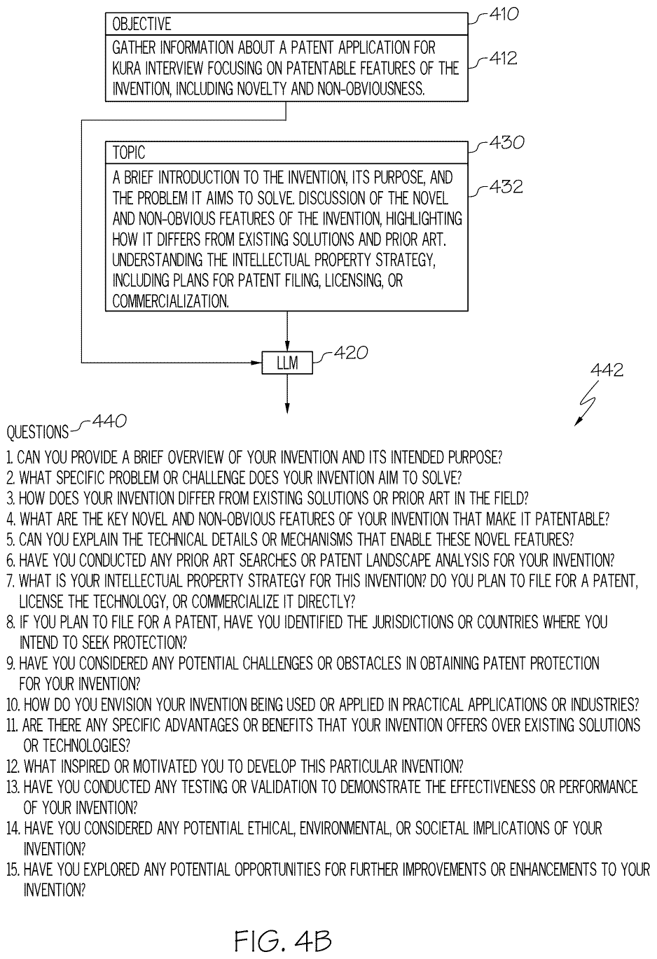

In step 310, the knowledge acquisition system obtains, through an interface displayed on a screen, an objective of an interview from a user. In embodiments, the first user device 102 may display, on the user interface output device 107, a request for inputting an objective of an interview. For example, by referring to FIG. 4A, an objective prompt 410 may be displayed on the user interface output device 107 of the first user device 102. The user of the first user device 102 may input the content of objective 412 through the user interface input device 105. The content of the objective 412 may be transmitted to the server 120.

Referring back to FIG. 3, in step 320, the knowledge acquisition system derives one or more topics from the objective of the interview using a large language model and displays, on the interface, the one or more topics. By referring to FIG. 4A, in embodiments, the LLM 420, which may comparable to the LLM 128 of the server 120 or a local LLM stored in the first user device 102, receives the objective of the interview and outputs a topic. The topic is automatically generated without any manual input from the user. Then, the first user device 102 displays the topic section 430 along with the content of topic 432 generated by the LLM 420 on the user interface output device 107. In some embodiments, two or more topics are derived from the objective of the interview and each of the plurality of questions is assigned to one of the two or more topics.

Referring back to FIG. 3, in step 330, the knowledge acquisition system generates a plurality of questions using the LLM 128 based on the objective of the interview and the derived one or more topics. By referring to FIG. 4B, in embodiments, the LLM 128 receives the gathered content of objective 412 with the derived content of topic 432 as inputs and outputs a plurality of questions 442 in response to receiving the inputs. The plurality of questions 442 may be displayed under a question section 440 on the user interface output device 107 of the first user device 102 so that the user of the first user device 102 may take a look at specific questions to ask based on the objective that the user input.

In some embodiments, the user of the first user device 102 may select a list of questions out of the plurality of questions 442 and the selected questions along with the objective and the topics may be transmitted to a target user or an interviewee. The user may also set an interviewer for the interview and an observer who may see answers to the questions during the interview.

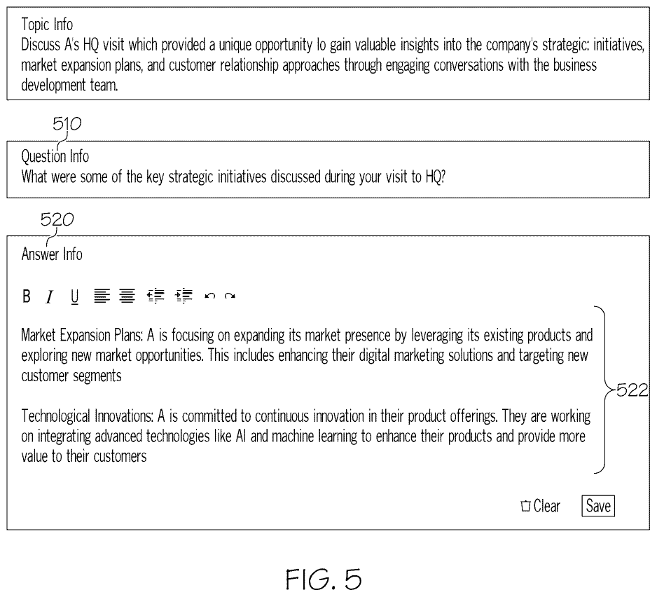

Referring back to FIG. 3, in step 340, the knowledge acquisition system provides the plurality of questions generated in step 330 to a target user. The target user may be a user of the second user device 160. In embodiments, the plurality of questions may be generated by the LLM 128 at the server 120 and transmitted from the server 120 to the second user device 160. In some embodiments, the plurality of questions may be locally generated at the second user device 160. Referring to FIG. 5, in embodiments, the second user device 160 may display on the user interface output device 167 at least one topic, at least one question 510, and a space 520 for a user to provide an answer to the at least one question on the user interface output device 167.

Referring back to FIG. 3, in step 350, the knowledge acquisition system obtains answers to the plurality of questions from the target user. Referring to FIG. 5, the target user of the second user device 160 may provide an answer 522 to a specific question 510 through the user interface input device 165. While FIG. 5 depicts an interface where the target user provides an answer to a single question, the interface may show a plurality of questions, and the target user may answer each of the questions. The target user may provide an answer by either typing or by utilizing text-to-speech technology.

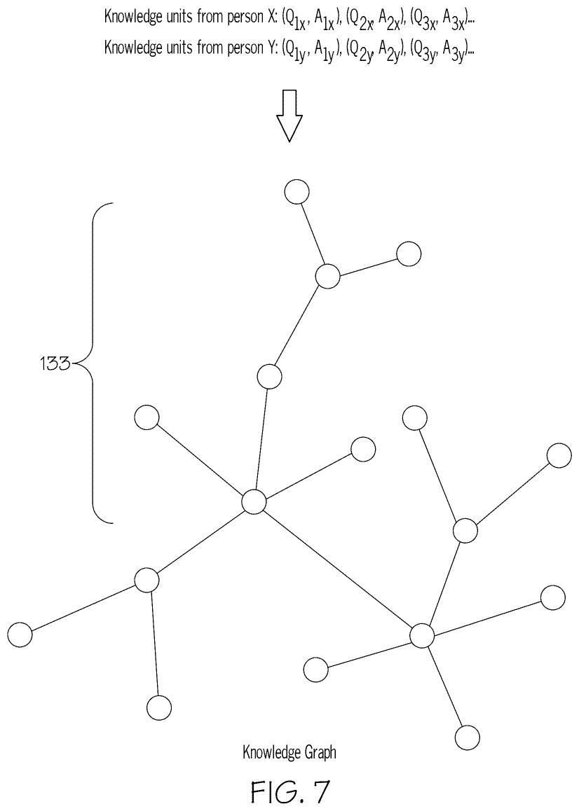

Referring back to FIG. 3, in step 360, the knowledge acquisition system gathers the plurality of questions provided in the interview and answers given by the target user and compiles them as a knowledge unit 131. For example, referring to FIG. 7, the knowledge acquisition system may provide a plurality of questions (Q_{1X}, Q_{2X}, . . . ) to a user device of person X to getting to know person X professionally regarding a certain topic. Person X's answers (A_{1X}, A_{2X}, . . . ) to the plurality of questions (Q_{1X}, Q_{2X}, . . . ) and the plurality of questions (Q_{1X}, Q_{2X}, . . . ) asked regarding the certain topic would be saved in the database 130 of the knowledge acquisition system as a knowledge unit 131. In a similar manner, the knowledge acquisition system may provide a plurality of questions (Q_{1Y}, Q_{2Y}, . . . ) to a user device of person Y to getting to know person Y professionally regarding the same or similar topic. Person Y's answers (A_{1Y}, A_{2Y}, . . . ) to the plurality of questions (Q_{1Y}, Q_{2Y}, . . . ) and the plurality of questions (Q_{1Y}, Q_{2Y}, . . . ) asked regarding the topic would be saved in the database 130 of the knowledge acquisition system as a knowledge unit 131. A plurality of knowledge units may be generated based on answers provided by multiple users for various topics. The plurality of knowledge units may be utilized to generate and update a knowledge graph 133.

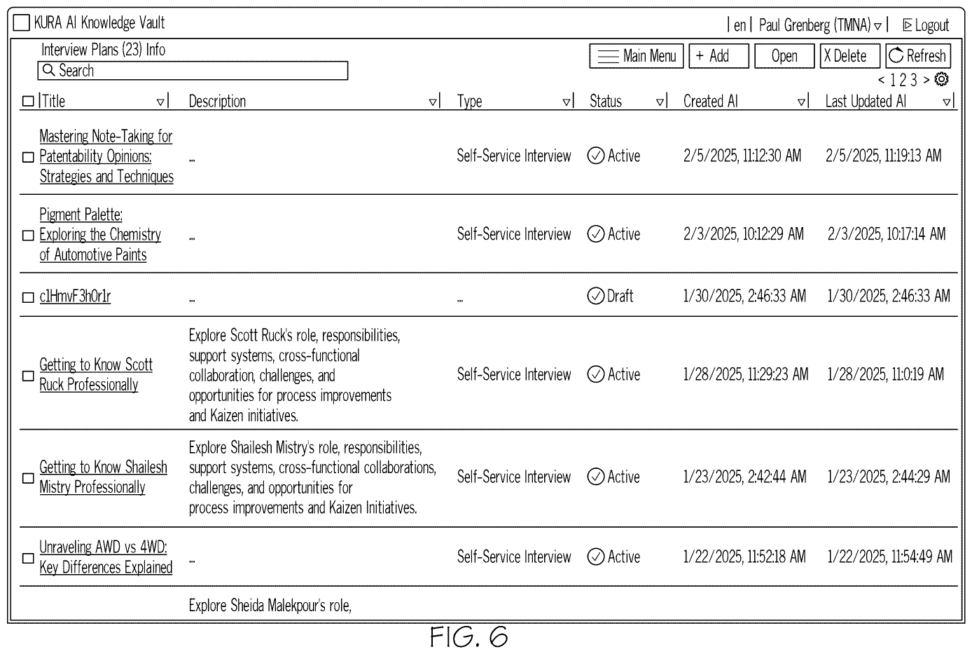

FIG. 6 depicts a user interface showing a list of interviews for acquiring knowledge from a plurality of users. Each of the interviews is directed to one or more topics. Each of the users may join one or more of the interviews that are related to her or him and provide answers to questions provided during the interview. Knowledge units 131 are generated based on the questions and answers from multiple users, the knowledge graph such as the knowledge graph 133 in FIG. 7 may be generated based on the knowledge units 131.

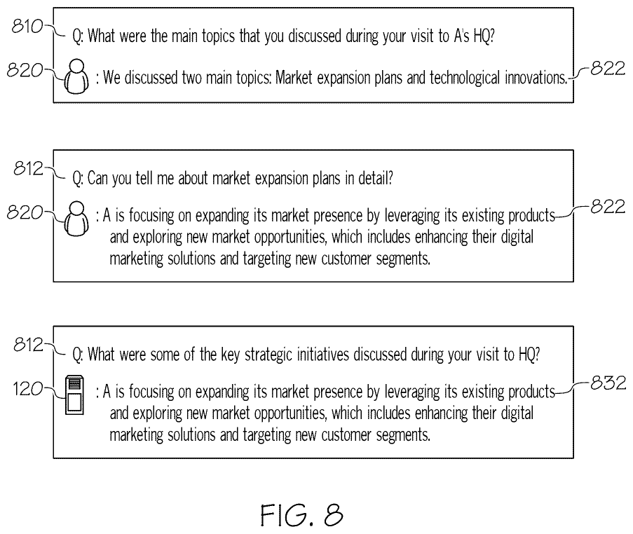

Referring back to FIG. 3, in step 370, the knowledge acquisition system may provide an answer to a question input by another user based on the saved knowledge units 131. For example, FIG. 8 illustrates a user interface of another user. Another user may be a person who wants to acquire knowledge from an expert having knowledge in a specific area. The expert may not available to communicate with another user in real time, or the expert may not be no longer with a firm to which another user belongs. Instead, the firm may store knowledge from the expert in the form of knowledge units 131 or a knowledge graph 133 based on a previous interview, e.g., an interview conducted as described with reference to steps 310 through 360 above. Then, the knowledge acquisition system of the firm may generate a virtual persona 820 of the expert and display the virtual persona 820 on the user interface of another user as illustrated in FIG. 8.

Another user may input a question 810 using an user interface input device of the user device of another user. In embodiments, the server 120 receives the question 810 and generates an answer 822 to the question 810 by utilizing the knowledge units 131 and/or the knowledge graph 133 in the database 130. In some embodiments, the user device of another user may store knowledge units 131 and/or knowledge graphs 133, and generate an answer 822 to the question 810 by utilizing the knowledge units 131 and/or knowledge graph 133 stored in the user device locally. The knowledge units 131 includes questions, answer to the questions, and topics for the questions and may also include other information such as identity information about an interviewee and/or interviewer, the time of the interview, the location of the interview, and the like.

The user device of another user may output the answer 822 using a user interface output device. The answer 822 may be displayed next to the virtual persona 820 of the expert as if the expert answers the question in real time. Then, another user may ask a follow up question 812 in response to the answer 822 provided. In a similar manner as generating the answer 822, the server 120 or the user device of another user may generate an answer 832 to the question 812 by utilizing knowledge units 131 and/or a knowledge graph 133.

In some embodiments, there may be multiple digital personas in the conversation with another user and the multiple digital personas may all answer questions provided by the user.

In embodiments, the answers such as the answers 822 and 832 to the another user's questions may correspond to the answers that were saved in the database 130 as a knowledge unit 131 in their original interview.

In embodiments, the target user or the interviewee may provide feedback to the questions by prioritizing the questions, answering the questions, or deleting some questions.

The feedback provides significance of the questions. For example, if the interviewee deleted some questions, the AI model or LLM of the knowledge acquisition system may recognize the questions as irrelevant or less important. Also, the AI model or LLM may prioritize the questions based on the prioritizing feedback from the interviewee.

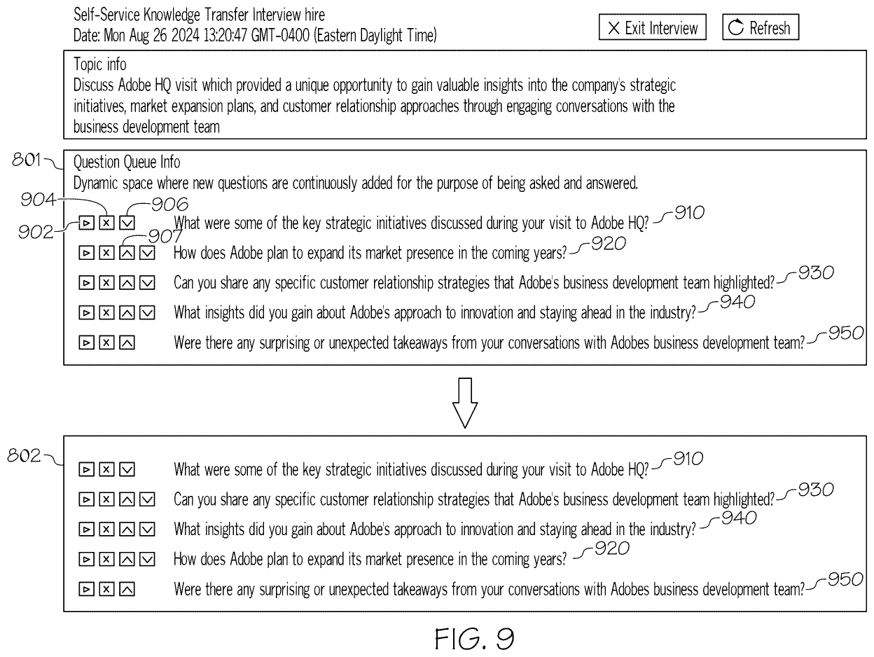

In embodiments, the interviewee may prioritize the received questions by changing the order to the questions. For example, FIG. 9 shows five questions 910, 920, 930, 940, and 950 provided to the interviewee. The questions are ordered in a first order 801. The interviewee may change the order of the questions by clicking the downward arrow 906 or the upward arrow 907 for corresponding questions. Specifically, the interviewee may move the second question 920 to the top by clicking the upward arrow 907. Then, the questions are reordered in a second order 802. The questions may be given weights based on their order. Specifically, the question at the top after reorder is given the highest weight, and the questions at the bottom after reorder is given the lowest weight. The present system obtains information that the plurality of questions 801 is reordered in the second order 802 by the subject, and gathers the reordered plurality of questions 802 and answers to the reordered plurality of questions 802 along with information about the reorder of the plurality of questions 802 as a knowledge unit 131. The information about the reorder of the plurality of questions 802 may include the weights given to the questions based on the reorder. The weights may include information about the degree of relevance to the provided topic, relevance to the expertise of the interviewee, the project of the interviewee, and the like. The gathered knowledge unit 131 may be used to train the AI model or LLM such that the further trained AI model may generate questions that are more specifically tailored for future interviewees.

In embodiments, the interviewee may edit the questions. For example, the interviewee may rephrase a question to make it clearer, change certain terms in the question to more appropriate terms such as terms that are more commonly used in the technical field of the topic of the interview, or change the question to be more specific such that a future interviewee can provide more detailed answers. The edits of the questions may be used to train the AI model such that the further trained AI model may generate questions that are more specifically tailored for future interviewees.

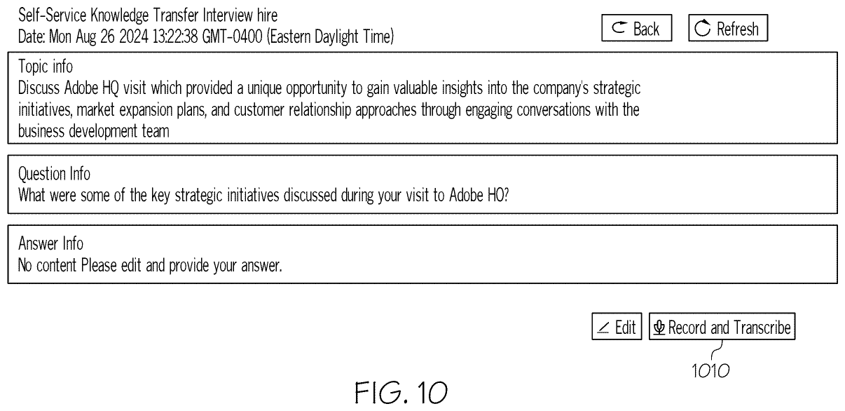

When answering the questions, the interviewee may provide answers in different methods. The interviewee may input text. The interviewee may also upload an image or blog post on social media. The interviewee may also use voice recording function to provide answers. For example, by referring to FIG. 10, the interviewee may click the Record and Transcribe button 1010, and provide input by allowing the present system to record the voice of the interviewee. While transcribing the voice, the present system may use a specific model tailored to a certain area. For example, when the interviewee is a person from a hybrid vehicle manufacturing department, a specific model that recognizes various acronyms/jargons is used to transcribe the voice with the appropriate interpretation of acronyms/jargons.

Once the interviewee submits answers, the present system creates one knowledge unit that includes both questions and answers along with other information such as information about the interviewer, the interviewee, objectives, topics, and the like. The present system may gather knowledge units from a plurality of interviewees. The gathered knowledge units are used to generate and update a knowledge graph. The generated/updated knowledge graph may be used to generate a dataset for training a machine learning model that generates questions based on provided objective/topics from an interviewer or answers from an interviewee.

In embodiments, an interviewer or observer may generate a digital twin for an interview conducted. The digital twin may be used to validate the knowledge unit by comparing the answers provided by the digital twin to the answers provided in the original interview.

The present disclosure performs knowledge acquisition through streamlined interviews that conduct employee interviews based on AI generated questions and gather valuable insights and information from long-standing employees.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for acquiring knowledge based on an interview, the method comprising:
obtaining, through an interface displayed on a screen, an objective of an interview from a user;
deriving one or more topics from the objective of the interview using a large language model (LLM) and displaying, on the interface, the one or more topics;
generating a plurality of questions using the LLM based on the objective of the interview and the derived one or more topics;
providing the plurality of questions to a target user;
obtaining answers to the plurality of questions from the target user;
gathering the plurality of questions and the answers as knowledge units; and
providing an answer to a question input by another user based on the knowledge units.

2. The method of claim 1, further comprising:
updating a knowledge graph based on the knowledge unit; and
training a machine learning model using the knowledge graph.

3. The method of claim 1, further comprising:
filtering the one or more topics based on an input by the user to the interface; and
generating the plurality of questions using the LLM based on the objective of the interview and the filtered topics.

4. The method of claim 1, wherein:
two or more topics are derived from the objective of the interview; and
each of the plurality of questions is assigned to one of the two or more topics.

5. The method of claim 1, wherein providing the answer to the question input by another user based on the knowledge unit comprises:
displaying, on the interface, a virtual persona of the target user in response to selection of the target user by the another user; and
displaying, on the interface, the virtual persona providing the answer to the question input by the another user.

6. The method of claim 5, further comprising:
comparing the answers provided by the virtual persona of the target user to one or more previous answers provided by the target user; and
validating accuracy of the knowledge unit based on the comparison.

7. The method of claim 1, wherein:
the plurality of questions is provided to a target subject in a first order;
the method further comprises:
obtaining information that the plurality of questions is reordered in a second order by the target subject; and
gathering the reordered plurality of questions and answers to the reordered plurality of questions along with information about the reorder of the plurality of questions as the knowledge units.

8. The method of claim 1, further comprising:
obtaining voice input from the target subject;
transcribing the voice to text;
interpreting the text using an model trained based on acronyms or jargons related to a predetermined technical field; and
storing the interpreted text as the answers.

9. The method of claim 1, further comprising
generating additional questions for the target subject using the LLM based on the answers obtained from the target user.

10. The method of claim 1, wherein the target user may provide feedback to the LLM, wherein the feedback comprises:
ranking the plurality of questions;
answering the plurality questions; or
deleting the plurality questions.

11. The method of claim 10, wherein the LLM prioritizes the plurality of questions based on the feedback provided from the target user.

12. The method of claim 10, further comprising:
receiving edits of the plurality of questions from the user; and
training the LLM based on the edits of the plurality of questions.

13. A system for acquiring knowledge based on an interview, the system comprising:
one or more processors; and
one or more memories for storing and encoding computer executable instructions that, when executed by the one or more processors is operative to:
obtain, through an interface displayed on a screen, an objective of an interview from a user;
derive one or more topics from the objective of the interview using a large language model (LLM) and displaying, on the interface, the one or more topics;
generate a plurality of questions using the LLM based on the objective of the interview and the derived one or more topics;
provide the plurality of questions to a target user;
obtain answers to the plurality of questions from the target user;
gather the plurality of questions and the answers as knowledge units; and
provide an answer to a question input by another user based on the knowledge unit.

14. The system of claim 13, wherein the computer executable instructions, when executed by the one or more processors, are operative to:
update a knowledge graph based on the knowledge units; and
train the LLM using the knowledge graph.

15. The system of claim 13, wherein the computer executable instructions, when executed by the one or more processors, are further operative to:
filter the one or more topics based on an input by the user to the interface; and
generate the plurality of questions using the LLM based on the objective of the interview and the filtered topics.

16. The system of claim 14, wherein the computer executable instructions, when executed by the one or more processors, are further operative to:
derive two or more topics from the objective of the interview; and
assign each of the plurality of questions to one of the two or more topics.

17. The system of claim 14, wherein the computer executable instructions, when executed by the one or more processors, are further operative to:
display, on the interface, a virtual persona of the target user in response to selection of the target user by the another user; and
display, on the interface, the virtual persona providing the answer to the question input by the another user.

18. The system of claim 17, wherein the computer executable instructions, when executed by the one or more processors, are further operative to:
compare the answers provided by the virtual persona of the target user to one or more previous answers provided by the target user; and
validate accuracy of the knowledge unit based on the comparison.

19. The system of claim 14, wherein the computer executable instructions, when executed by the one or more processors, are further operative to:
provide the plurality of questions is to a target subject in a first order;
obtain information that the plurality of questions is reordered in a second order by the target subject; and
gather the reordered plurality of questions and answers to the reordered plurality of questions along with information about the reorder of the plurality of questions as the knowledge units.

20. The system of claim 19, wherein the computer executable instructions, when executed by the one or more processors, are further operative to:
generate additional questions for the target subject using the LLM based on the answers obtained from the target user.
